(19) United States
(12) Patent Application Publication
(10) Pub. No.: US 2009/0182506 A1
(43) Pub. Date: Jul. 16, 2009

(54) COLLISION-PREVENTING DEVICE FOR AIRPLANE MOVING ON GROUND AND AIRPLANE WITH THE SAME

(76) Inventor: In-Jong Yun, GIMPO-SI (KR)

Correspondence Address: IPLA P.A., 3580 WILSHIRE BLVD., 17TH FLOOR, LOS ANGELES, CA, 90010, US

(21) Appl. No.: 12/348,717

(22) Filed: Jan. 5, 2009

(30) Foreign Application Priority Data
Jan. 10, 2008 (KR) 10-2008-0002978

(51) Int. Cl. G08G 5/04

(52) U.S. Cl. 701/301

(57) ABSTRACT

A collision-preventing device for an airplane moving(parking or taxing) on the ground and an airplane with the same comprises first and second laser emission means engaged in the tips of the wings of an airplane for emitting laser in a downward direction, respectively, wherein said first laser emission means vertically emits a position indication laser for indicating the positions of the tips, and said second laser emission means forwardly emits a direction indication laser at an inclined angle for indicating the moving directions of the wings, and a line connecting a point that the position indication laser is emitted on the ground and a point that the direction indication laser is emitted on the ground is parallel with a central axis line of the airplane, and when the airplane is stationed on the ground, the first and second laser emission means are in the operation mode all the time.

### CROSS REFERENCE

This application claims foreign priority under Paris Convention and 35 U.S.C. §119 to Korean Patent Application No. 10-2008-0002978, filed Jan. 10, 2008 with the Korean Intellectual Property Office.

### BACKGROUND OF THE INVENTION

1. Field of the Invention

The present invention relates to a device for preventing a collision between airplanes, and in particular to a collision-preventing device for an airplane moving on ground and an airplane with the same which are featured in that a collision between a wing of an airplane which is moving on the ground and a wing of an airplane which is stationed on the ground can be reliably prevented.

2. Background of the Invention

A human being has been dreaming of flying since long time ago. However, a human being couldn't fly for himself because no wing evolution was given to a human being. So, a human being made a so-called flying machine, airplane, with advanced hands and brain. Finally, a human being's dream for flying was achieved by Orville and Wilbur Wright who invented a glider in 1900.

Since Orville and Wilbur Wright invented the airplane, many persons competed to develop a new airplane which can fly faster and high. Consequently, various airplanes are developed 100 years after the invention of an airplane by Orville and Wilbur Wright. The airplanes are necessary items in recent years as key transportation means.

The airplanes are basically configured to fly in the sky. However, the airplanes move on the ground after landing on the ground or before taking off from the ground. The airplanes might collide with other airplanes while stationing on the ground or moving on the ground. So, it is very important to avoid collisions with other airplanes when moving on the ground.

So far, no device is invented in order to prevent collisions between airplanes moving on the ground. The collisions are prevented only depending on a pilot's visibility and experiences. In case of a passenger airplane, and first officer checks the position of a right wing through a right window and a moving direction, and a captain checks the position of a left wing through a left window and a moving direction for thereby preventing any collisions with other airplanes.

Driving the airplanes as the captain and first officer are checking only the positions of the wings and the moving direction might be very hard work in case that their space recognition abilities are poor. Even when they have excellent space recognition abilities, such driving operation needs a lot of hard work.

### SUMMARY OF THE INVENTION

Accordingly, it is an object of the present invention to provide a collision-preventing device for an airplane moving on the ground and an airplane with the same which are able to overcome the problems found in the conventional art and are characterized in that when driving an airplane on the ground, the pilots can more reliably check the positions of wing ends(wing tips) and a moving directions, so the pilots can drive (taxi) the airplanes on the ramp in the busy airport in more safe without collisions.

To achieve the above objects, there is provided a collision-preventing device for an airplane moving on the ground which comprises first and second laser emission means engaged in the tips of the wings of an airplane for emitting laser in a downward direction, respectively, wherein said first laser emission means vertically emits a position indication laser for indicating the positions of the tips of the wing, and said second laser emission means forwardly emits a direction indication laser at an inclined angle for indicating the moving directions of the wings, and a line connecting a point that the position indication laser is emitted on the ground and a point that the direction indication laser is emitted on the ground is parallel with a central axis line of the airplane, and when the airplane is parking or taxing on the ground, the first and second laser emission means are in the operation mode all the time.

Preferably, the first and second laser emission means are installed in the interior of a navigation light box, respectively. In this case, first it is not needed to form an additional space for installing the first and second laser emission means in the wings of the airplane, it is easy to install the first and second laser emission means. Second, since the first and second laser emission means are not protruded from the underneath surfaces of the wings, an air flow passing past the wings does not change.

Preferably, the first and second laser emission means operate when a landing gear lever installed in a control panel of a cockpit of an airplane is a down position (Ground Mode), and does not operate when the landing gear lever is in an up position (Air Mode). With the above construction, since it is not needed to operate the on/off of the first and second laser emission means through a button, it is very easy to operate the first and second laser emission means.

To achieve the above objects, there is provided an airplane which is equipped with a collision-preventing device for an airplane moving (taxing) on the ground.

According to the present invention, since a pilot can more reliably check whether the wings of his airplane approaches a wing of other airplanes or not for thereby more easily and reliably prevent a collision between airplanes.

### BRIEF DESCRIPTION OF THE DRAWINGS

The present invention will become better understood with reference to the accompanying drawings which are given only by way of illustration and thus are not limitative of the present invention, wherein;

FIG. 1 is a plane view illustrating an airplane having a collision prevention device according to the present invention;

FIG. 2 is a perspective enlarged view illustrating a portion A of FIG. 1;

FIG. 3 is a front view illustrating an airplane of FIG. 1; and

FIG. 4 is a left side view illustrating an airplane of FIG. 1.

### DESCRIPTION OF THE PREFERRED EMBODIMENTS

The collision-preventing device for an airplane parking or taxing on the ground and an airplane with the same according to the present invention will be described with reference to the accompanying drawings.

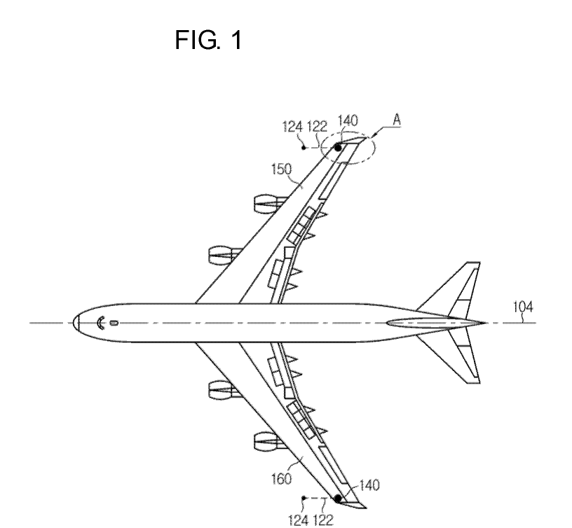

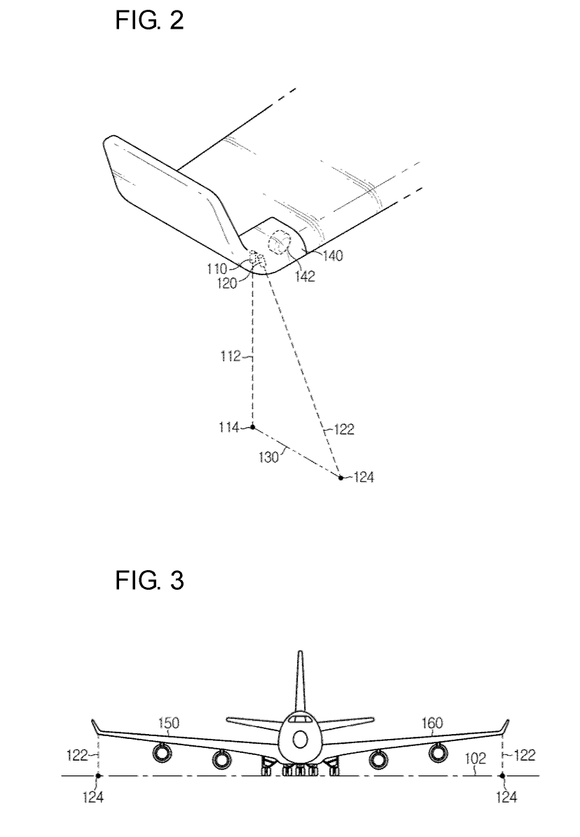

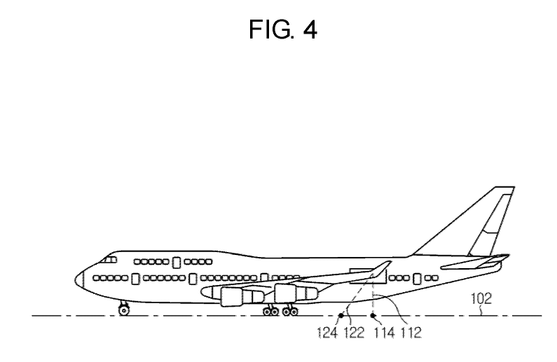

FIG. 1 is a plane view illustrating an airplane having a collision prevention device according to the present invention. FIG. 2 is a perspective enlarged view illustrating a portion A of FIG. 1. FIG. 3 is a front view illustrating an airplane of FIG. 1. FIG. 4 is a left side view illustrating an airplane of FIG. 1.

The collision prevention device according to the present invention comprises a first laser emission unit 110, and a second laser emission unit 120. Here, the first and second laser emission units 110 and 120 are mounted in a space (not shown) formed in the tips of right and left wings 150 and 160 of an airplane. The underneath surfaces of the space are transparent enough to transmit lasers 112 and 122 projected from the first and second laser emission units 110 and 120, and the above space is configured while not changing the original shapes of the wings 150 and 160. When the original shapes of the wings 150 and 160 are changed due to the addition of the space, an air flow passing past the wings 150 and 160 might be changed. The first and second laser emission units 110 and 120 are preferably installed at the tips of the wings of the airplane in the known laser emission device and are preferably emit red lights. In case that the lasers 112, 114 and 122, 124 are red, the pilots can more reliably check the lasers 112, 114 and 122, 124.

The first and second laser emission units 110 and 120 are installed in the space(not shown) formed in the tips of the wings 150 and 160. However, it is most preferred that the first and second laser emission units 110 and 120 are installed in the interior of a navigation light box which is generally installed in the tips of the wings 150 and 160. In this case, since the airplane does not need any space for installing the first and second laser emission units in the wings of the airplane, it is very easy to install the first and second laser emission units without changing the configurations of the wings. At this time, the first and second laser emission units 110 and 120 are installed in the interior of the navigation light box 140 while being slightly inclined in the directions of the tips of the wings with respect to the navigation light 142. With the above construction, the position indication laser 112 can reliably indicate the positions of the tips of the wings.

The first and second laser emission units 110 and 120 are configured to emit lasers 112 and 122 toward the lower sides of the wings 150 and 160. In the first laser emission unit 110, the position indication laser 112 emits light vertically with respect to the ground 102 for thereby indicating the position of the tip of each wing 150 and 160 on the ground 102, and in the second laser emission unit 120, the direction indication laser 122 emits light in the forward direction of the airplane so as to indicate the moving direction of the tip of each wing 150 and 160 on the ground. At this time, a line 130 between the point 114 that the position indication laser 112 and the ground meet with each other the point 124 that the direction indication laser 122 and the ground 102 meet with each other is parallel with the center line 104 which divides the airplane into two parts.

The first and second laser emission units 110 and 120 emit the position indication laser 112 and the direction indication laser 122 all the time when the airplane is parking on the ground. Here, the above event that the airplane is stationed on the ground means that the wheels of the airplane are touching with the ground 102 like the airplane moves on the ground.

The first and second laser emission units 110 and 120 are configured as described above. The operations of the same are as follows. The pilots of the airplane can visually check through the side windows the tips of the wings 150 and 160, the point 144 that the position indication laser 112 and the ground 102 meet with each other, and the point 124 that the direction indication laser 122 and the ground 102 meet with each other, respectively. In addition, the pilots of the airplane can visually check through the side windows the tips of the wings of other airplane, the point that the position indication laser and the ground 102 meet with each other, and the point that the direction indication laser of other planes and the ground 102 meet with each other, respectively.

So, the pilot of the airplane can check whether the above point might approach the point that the position indication laser of other plane and the ground 102 meet with each other or the point that the direction indication laser of other airplane and the ground 102 meet with each other, or whether the above point are getting far from the same. When the point 124 approaches the point that the position indication laser of other airplane and the ground 102 meet with each other or the point that the direction indication laser of other airplane and the ground 102 meet with each other, it means that the tips of the wings of his airplane are approaching the tips of the wings of other airplanes. When the above states continue, the wings of both the airplanes collide with each other soon. So, when the pilot of the airplane knows that the point 124 are approaching the point that the position indication laser of other airplane and the ground 102 meet with each other or the point that the direction indication laser of other airplane and the ground 102 meet with each other, the pilot is needed to change the moving direction of the airplane as soon as possible for thereby preventing both the airplanes from colliding with each other.

As described earlier, when the airplane is parking on the ground, the first and second laser emission units 110 and 120 emit lasers 112 and 122. However, even when the first and second laser emission units 110 and 120 continue to emit laser after the airplane took off, it might cause visual problems. So, the first and second laser emission units 110 and 120 need a certain device for controlling the on/off of the same.

The on/off of the first and second laser emission units 110 and 120 are manually controlled using a button(not shown) disposed on a control panel of a cockpit of the airplane. As the pilot manually operates the button(not shown), it is possible to operate the first and second laser emission units 110 and 120 before or after landing. In addition, it is possible to stop the operations of the first and second laser emission units 110 and 120 before or after taking off of the airplane.

As an alternative, with an automatic operation mode, the first and second laser emission units 110 and 120 operate when a landing gear lever installed in the control panel of the cockpit is in a down position, and when it is in an up position, their operations stop. In this case, the operations of the first and second laser emission units 110 and 120 are very easy since it does not need to operate the on/off of the first and second laser emission units 110 and 120 through the buttons. For reference, the landing gear lever is used for retracting the wheels of the airplane into the interior of the airplane or extending the same to the outside of the airplane. When the landing gear lever is in an up position, the wheels are retracted into the interior of the airplane, and when it is in a down position, the wheels are extended to the outside of the airplane.

In addition, the on/off of the first and second laser emission units 110 and 120 might be selected between the manual mode and the automatic mode. For example, a 3-step switch might be installed in the control panel of the cockpit. In the first step of the switch, it might be set to the on of the manual mode, and in the second step of the switch, it might be set to the off of the manual mode. In the third step of the switch, it might be set to the automatic mode. When the on/off modes of the first and second laser emission units 110 and 120 are configured to be selectable, the pilot of the airplane can select a desired operation mode depending his preference.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A collision-preventing device for an airplane moving on the ground, comprising:
first and second laser emission means engaged in the tips of the wings of an airplane for emitting laser in a downward direction, respectively, wherein said first laser emission means vertically emits a position indication laser for indicating the positions of the tips of the wing, and said second laser emission means forwardly emits a direction indication laser at an inclined angle for indicating the moving directions of the wings, and a line connecting a point that the position indication laser is emitted on the ground and a point that the direction indication laser is emitted on the ground is parallel with a central axis line of the airplane, and when the airplane is parking or taxing on the ground, the first and second laser emission means are in the operation mode all the time.

2. The device of claim 1, wherein said first and second laser emission means are installed in the interior of a navigation light box, respectively.

3. The device of claim 1, wherein said first and second laser emission means operate when a landing gear lever installed in a control panel of a cockpit of an airplane is a down position, and does not operate when the landing gear lever is in an up position.

4. An airplane which is equipped with a collision-preventing device for an airplane moving on the ground of claims 1.
